(19) United States
(12) Patent Application Publication
(10) Pub. No.: US 2013/0209808 A1
(43) Pub. Date: Aug. 15, 2013

(54) CAPACITIVE TOUCH UNIT

(71) Applicant: Chih-Chung Lin, Taipei City (TW)

(72) Inventor: Chih-Chung Lin, Taipei City (TW)

(73) Assignee: Chih-Chung Lin, Taipei City (TW)

(21) Appl. No.: 13/442,869

(22) Filed: Apr. 10, 2012

(30) Foreign Application Priority Data
Feb. 15, 2012 (TW) 101104831

(51) Int. Cl. B32B 17/06; B32B 27/28; B32B 27/06; B32B 27/32; B32B 17/00; B32B 27/36

(52) U.S. Cl. 428/412; 428/426; 428/480; 428/523; 428/500; 428/432

(57) ABSTRACT

A capacitive touch unit includes a transparent substrate, a polymeric transparent substrate, a second conductive layer and an adhesive layer. The transparent substrate is coated with at least one first conductive layer and is correspondingly attached to the polymeric transparent substrate. The second conductive layer is selectively disposed on one of two sides of the polymeric transparent substrate. The adhesive layer is disposed between the transparent substrate and the polymeric transparent substrate. By means of the capacitive touch unit, the thickness can be greatly reduced and the manufacturing cost can be greatly lowered.

This application claims the priority benefit of Taiwan patent application number 101104831 filed on Feb. 15, 2012.

### BACKGROUND OF THE INVENTION

1. Field of the Invention

The present invention relates generally to a capacitive touch unit, and more particularly to a capacitive touch unit, which can reduce the thickness and lower the manufacturing cost.

2. Description of the Related Art

In recent years, following the development of touch panel technique, various portable electronic devices with display function, such as intelligent cellular phones, tablets and MP5, have employed touch panels instead of the conventional mechanical pushbuttons that occupy much room.

In the existent touch panels, most of the touch panels adopted in the portable electronic devices are capacitive touch panels. An ordinary capacitive touch panel includes a transparent substrate. An indium tin oxide (ITO) layer is disposed on a bottom face of the transparent substrate. The periphery of the bottom face serves as a wiring section. Multiple electrodes are formed on the indium tin oxide (ITO) layer. Multiple leads are disposed on the wiring section and electrically connected to the electrodes respectively. The leads are non-transparent bodies. Therefore, it is necessary for the electronic device manufacturer to spray an ink layer on the periphery of a bottom section of a protection board and dispose an adhesive layer on a top face of the touch panel for adhering the touch panel to the protection board. The ink layer of the bottom face of the protection board corresponds to the wiring section of the touch panel for concealing the leads arranged in the wiring section of the touch panel. The ink layer and the adhesive layer not only lead to increase of manufacturing cost and material cost of the electronic device, but also lead to increase of the total thickness of the electronic device. As a result, the portable electronic device can be hardly slimmed, miniaturized and lightened. This problem must be solved.

Some manufacturers manufacture the touch panels by means of lithography. Such technique can meet the requirement for thinning the touch panel. However, the manufacturing cost is greatly increased. Therefore, the conventional touch panel has the following shortcomings:

1. The conventional touch panel has larger thickness.

2. The manufacturing cost of the conventional touch panel is higher.

### SUMMARY OF THE INVENTION

A primary object of the present invention is to provide a capacitive touch unit, which can reduce the total thickness of the capacitive touch panel.

A further object of the present invention is to provide the above capacitive touch unit, which can greatly lower the manufacturing cost.

To achieve the above and other objects, the capacitive touch unit of the present invention includes a transparent substrate, a polymeric transparent substrate, a second conductive layer and an adhesive layer.

The transparent substrate has a first side and a second side. The second side is coated with at least one first conductive layer. The polymeric transparent substrate has a third side and a fourth side. The third side is correspondingly attached to the first conductive layer. The second conductive layer is selectively disposed on the third side or the fourth side of the polymeric transparent substrate. The adhesive layer is disposed between the transparent substrate and the polymeric transparent substrate.

By means of the capacitive touch unit of the present invention, the total thickness of the capacitive touch panel can be greatly reduced and the manufacturing cost of the capacitive touch panel can be greatly lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a first embodiment of the capacitive touch unit of the present invention;

FIG. 2 is a sectional view of the first embodiment of the capacitive touch unit of the present invention;

FIG. 3 is a sectional view of a second embodiment of the capacitive touch unit of the present invention; and

FIG. 4 is a sectional view of a third embodiment of the capacitive touch unit of the present invention.

### DETAILED DESCRIPTION OF THE PREFERRED EMBODIMENTS

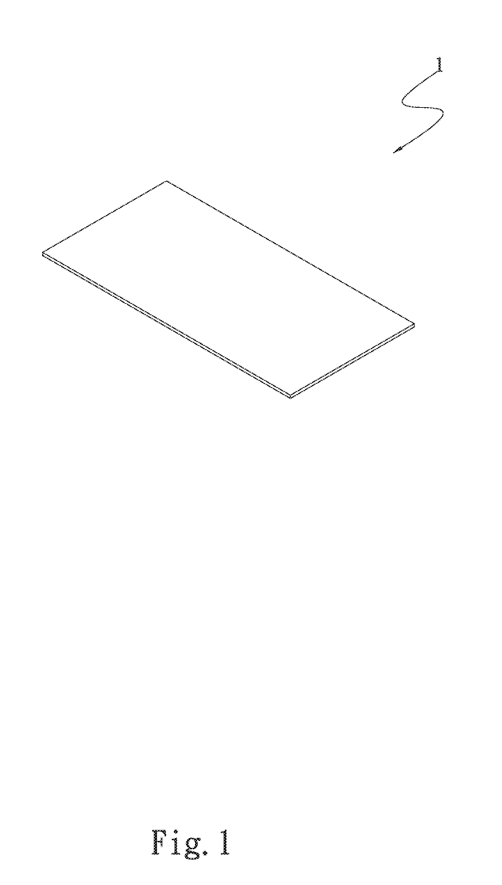

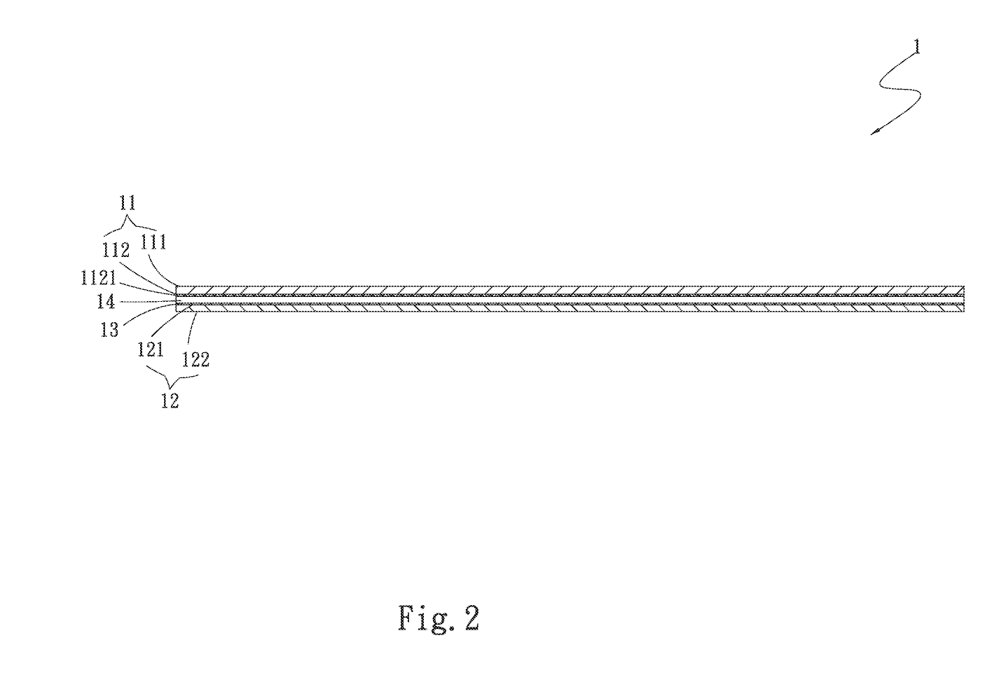

Please refer to FIGS. 1 and 2. FIG. 1 is a perspective view of a first embodiment of the capacitive touch unit of the present invention. FIG. 2 is a sectional view of the first embodiment of the capacitive touch unit of the present invention. According to the first embodiment, the capacitive touch unit 1 of the present invention includes a transparent substrate 11, a polymeric transparent substrate 12, a second conductive layer 13 and an adhesive layer 14.

The transparent substrate 11 has a first side 111 and a second side 112. The second side 112 is coated with at least one first conductive layer 1121.

The polymeric transparent substrate 12 has a third side 121 and a fourth side 122. The third side 121 is correspondingly attached to the first conductive layer 1121.

The second conductive layer 13 is selectively disposed on the third side 121 or the fourth side 122 of the polymeric transparent substrate 12. In this embodiment, the second conductive layer 13 is disposed on the third side 121 of the polymeric transparent substrate 12.

The adhesive layer 14 is disposed between the transparent substrate 11 and the polymeric transparent substrate 12.

The transparent substrate 11 is selected from a group consisting of a glass substrate and a polymeric transparent substrate. In this embodiment, the transparent substrate 11 is, but not limited to, a glass substrate for illustration purposes only.

The material of the polymeric transparent substrate 12 is selected from a group consisting of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC). In this embodiment, the polymeric transparent substrate 12 is, but not limited to, a polyethylene terephthalate (PET) substrate for illustration purposes only.

The adhesive layer 14 is selected from a group consisting of optical clear adhesive (OCA) and optical clear resin (OCR).

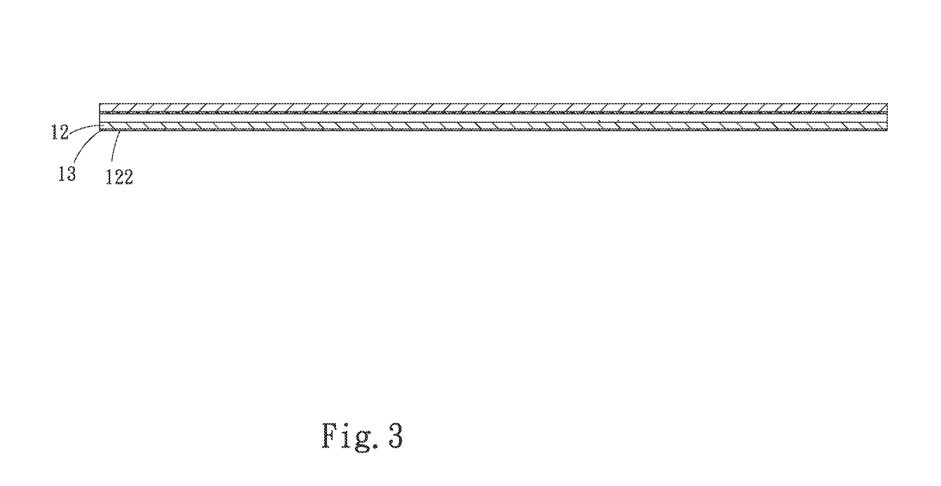

Please now refer to FIG. 3, which is a sectional view of a second embodiment of the capacitive touch unit of the present invention. The second embodiment is partially identical to the first embodiment in structure and thus will not be repeatedly described hereinafter. The second embodiment is different from the first embodiment in that the second conductive layer 13 is disposed on the fourth side 122 of the polymeric transparent substrate 12.

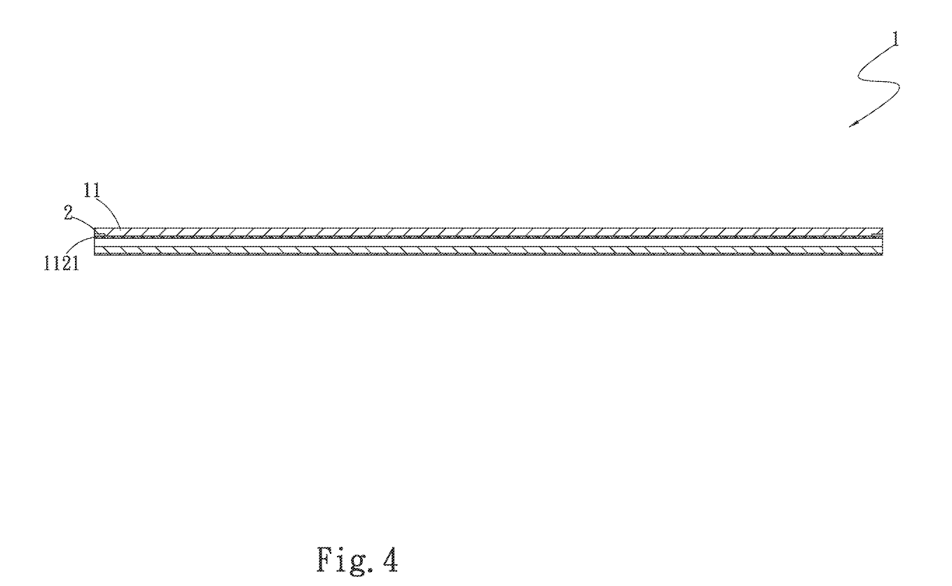

Please now refer to FIG. 4, which is a sectional view of a third embodiment of the capacitive touch unit of the present invention. The third embodiment is partially identical to the first embodiment in structure and thus will not be repeatedly described hereinafter. The third embodiment is different from the first embodiment in that the capacitive touch unit 1 further includes a shield body 2. The shield body 2 is disposed between the transparent substrate 11 and the first conductive layer 1121 in adjacency to a lateral side of the transparent substrate 11.

In the first and third embodiments, the first and second conductive layers 1121, 13 are transparent conductive layers. The transparent conductive layers are coating structures formed by means of gelatinization, plating, evaporation or sputtering. The coating structure is selected from a group consisting of indium tin oxide (ITO), indium zinc oxide (IZO) and antimony tin oxide (ATO).

By means of the structural design of the capacitive touch unit 1 of the present invention, the problem existing in the conventional touch panel that the conventional touch panel cannot be thinned can be solved. Moreover, the manufacturing cost can be greatly lowered.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

1. A capacitive touch unit comprising:
a transparent substrate having a first side and a second side, the second side being coated with at least one first conductive layer;
a polymeric transparent substrate having a third side and a fourth side, the third side being correspondingly attached to the first conductive layer;
a second conductive layer selectively disposed on the third side or the fourth side of the polymeric transparent substrate;
an adhesive layer disposed between the transparent substrate and the polymeric transparent substrate; and
a shield body, the shield body being disposed between the transparent substrate and the first conductive layer in adjacency to a lateral side of the transparent substrate.

2. The capacitive touch unit as claimed in claim 1, wherein the transparent substrate is selected from the group consisting of a glass substrate and a polymeric transparent substrate.

3. The capacitive touch unit as claimed in claim 1, wherein the material of the polymeric transparent substrate is selected from the group consisting of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

4. The capacitive touch unit as claimed in claim 1, wherein the adhesive layer is selected from the group consisting of optical clear adhesive (OCA) and optical clear resin (OCR).

5. (canceled)

6. The capacitive touch unit as claimed in claim 1, wherein the first and second conductive layers are transparent conductive layers, the transparent conductive layers being coating structures formed by means of gelatinization, plating, evaporation or sputtering, the coating structure being selected from the group consisting of indium tin oxide (ITO), indium zinc oxide (IZO) and antimony tin oxide (ATO).
